(19) United States
(12) Patent Application Publication
(10) Pub. No.: US 2008/0249841 A1
(43) Pub. Date: Oct. 9, 2008

(54) SYSTEM AND METHOD FOR GENERATING AND PAYING FOR AD LISTINGS FOR ASSOCIATION WITH SEARCH RESULTS OR OTHER CONTENT

(76) Inventors: William Marcus RUARK, Prosper, TX (US); Matthew Trent SABINO, Albuquerque, NM (US); Matthew David WELLS, Bernalillo, NM (US)

Correspondence Address: WILMERHALE/BOSTON, 60 STATE STREET, BOSTON, MA, 02109, US

(21) Appl. No.: 12/061,605

(22) Filed: Apr. 2, 2008

Related U.S. Application Data
(60) Provisional application No. 60/921,288, filed on Apr. 2, 2007.
(60) Provisional application No. 60/993,357, filed on Sep. 13, 2007.

(51) Int. Cl. G06Q 30/00

(52) U.S. Cl. 705/10; 705/14

(57) ABSTRACT

A system and method is disclosed for providing targeted advertising for association with retrieved content on media, such as the Internet or World Wide Web, in such a way that it is not susceptible to click fraud. This system and method are directed to a “pay for share” system that provides billing before targeted advertisements are made available for selection for display.

### RELATED APPLICATIONS

This application claims the benefit of provisional application Ser. No. 60/921,288, filed Apr. 2, 2007, and provisional application Ser. No. 60/993,357, filed Sep. 13, 2007, both of which are incorporated in their entirety herein.

### FIELD OF THE INVENTION

The present invention relates to systems and methods that are used for associating advertisements with content retrieved on media such as the Internet or World Wide Web (WWW). More specifically, the present invention relates to systems and methods that are used for the way advertisers pay for the placement of advertisements, and how those ads are selected for placement, with respect to content retrieved on media such as the Internet and WWW.

### BACKGROUND OF THE INVENTION

Over the last few years, media such as the Internet and WWW have seen dramatic increases in usage. This is due in large part to the worldwide increase in the number of computers, personal digital assistants (“PDAs”), and feature-rich cellular telephones. All of these devices use the Internet and WWW for many purposes, but one of the main purposes is to search for content stored on Web pages of these media.

The backbone of Internet or WWW systems is a search engine. Search engines may be of various types but have the same purpose: search for and retrieve desired content for end-users. End-users do this by entering specific search requests or queries into search engines, and receiving search results in the form of content from available Web pages. These results may be ordered in various ways depending on the underlying structure of the search engine.

Marketers or advertisers have seized upon the notion of providing advertisements to end-users of the Internet or WWW. Initially, they sought to simply provide advertisements that may or may not have been associated with the content of the Web pages that were retrieved. As the Internet and WWW evolved and advertisers became more sophisticated, they have sought to provide targeted advertising that was directly associated with the content of retrieved Web pages.

Preferably, targeted advertising is displayed alongside Web-based content. As an example, an end-user may conduct an Internet search for car tires and several advertisements for tire companies and tire stores may be associated with the retrieved Web-based content. In like manner, an end-user reading a web log that discusses Zinfandel wine also may view advertisements for wine stores and specific wineries that specialize in Zinfandel wine. In these cases, the underlying advertising systems are targeting the appearance of specific advertisements based on the requested content by the end-user or the content of associated Web pages.

There are advertising systems that support targeted advertising based on the content of search queries (requests) or search results containing keywords or phrases that will trigger the association of a particular targeted ad with such content. An example of Internet-based search engines that have advertising systems of this type are Google®, a registered trademark of Google, Inc., AdWords®, a registered trademark of Google, Inc., and Yahoo®, a registered trademark of Yahoo, Inc.

Advertising systems that are associated with search engines may be sponsored by the search engine themselves or by others. Typically, advertising systems will have a mechanism to determine what targeted ads will be associated with specific retrieved content and order the targeted ads for display. The ordering of the targeted ads typically will be based on the amount bid by the advertiser for the keywords or phrases to trigger this association. For example, Tire Company A, Tire Company B, Tire Company C, Tire Company D, and other tire companies would like to be the first advertiser listed when the keyword “tires” is used in a search query or found in search results. Therefore, if the four tire companies shown were competing for listing preference for their targeted ads based on the keyword “tires,” if the bidding amounts in descending order were Tire Company C first, Tire Company B second, Tire Company D third and Tire Company A fourth, the ordering of these tire companies' targeted ads with the returned content would generally follow this order.

Advertising systems have been using the bidding method for some time for ordering targeted ads for association with retrieved content. Taking the tire example above and looking at it in greater detail, Tire Company C may have bid $0.10, Tire Company B may have bid $0.08, Tire Company D may have bid $0.05, and Tire Company A may have bid $0.03 for the keyword “tires.” Should one of these companies change their bid, then the ordering would be changed appropriately. For example, if Tire Company A chose to improve its rank, it may submit a new bid of $0.06 for this purpose. Such a bid, when processed, would improve its position to third.

The bidding method has a particular way for advertisers to pay for associating their targeted ad with content of search results. Payment under the bidding method is determined by end-user activities. Typically, it would be based on the end-user clicking on a specific ad. As used herein, “clicking” would refer to the end-user clicking on the displayed hyperlink of the advertisement. When the end-user clicks on the targeted advertisement, the search engine records the number of click-throughs and transmits this information to the advertising system. The amount that is billed an advertiser can vary by advertising system, but it is often determined by the next lowest amount bid for the keyword by the next advertiser for each click-through. Advertisers are billed periodically based on this calculation. The advertising systems that use this targeted advertising model are referred to as a “pay per click” system.

The bidding method has been useful in expanding targeted advertising on the Internet and WWW. However, bidding systems that are based on the number of times a targeted ad is clicked-through have certain inherent problems. One of the main problems is that the click-through type of system is susceptible to fraudulent activity. For example, someone or even a competitor could intentionally click an advertiser's hyperlink an inordinate number of times to falsely increase the amount to be billed the advertiser in an effort to force the advertiser to relinquish using a particular keyword or drain the advertiser's advertising budget. There should be a method in which click fraud is eliminated while at the same time providing an easy method by which advertisers may be billed for targeted advertising being associated with content retrieved or viewed by end-users.

### SUMMARY OF THE INVENTION

The present invention is a system and method for providing targeted advertising for association with content on media, such as the Internet or World Wide Web, which eliminates click fraud. The present invention is a “pay for share” system that determines billing before advertisers have their targeted ads entered into the system in such a way that they may be selected for association with the content.

According to the present invention, Internet or WWW content providers, such as search engines, that have sponsored advertising systems connected to, or incorporated with them, provide an opportunity for advertisers to select keywords or phrases or other identifying items that may be used by such advertisers to associate their targeted advertisements with the content of search queries, search results, or other content. In referring to a “keyword or phrase” herein, it is meant to include, but not be limited to, keywords, key phrases, queries, content, concepts, user behavior, user information, or context.

According to the present invention, advertisers will input the amount they are willing to pay to have their target ad associated with a particular keyword or phrase to the advertising system. Once this amount is paid by the advertiser for the keyword or phrase, ad information is stored in the advertising system for retrieval when the keyword or phrase is found in a search query, the content of search results, or otherwise associated with other forms of content. The advertising system will sort and order the targeted ads of multiple advertisers seeking to use the same keyword or phrase to associate such ads with such content. This ordering is typically based on the amount paid by the advertisers. The advertiser that paid the highest amount may be listed first in the ordering of the targeted ads for display next to retrieved content returned for a particular search request. However, on a case-by-case basis, the ordering will be based on the probability provided by the share paid for by an advertiser, where “share” is the ratio of the amount paid by such advertiser divided by the total amount paid by all advertisers for such research request. Therefore, if there were four advertisers that all sought to associate their ads with a particular keyword or phase, and Advertiser #1 paid 50% of the total amount paid by all advisers, Advertiser #2 paid 25%, Advertiser #3 paid 15%, and Advertiser #4 paid 10%, their ordering would be based on the probability of each Advertiser having a particular position. Thus, over a reasonable period of time, 50% of the time Advertiser #1 would be listed first. It is also seen that if one of the other advertiser were listed first based on their probability, then the probability that Advertiser #1 would be listed second is very high compared to the probability of other remaining advertisers.

When an advertiser pays for a keyword or phrase or other targeting variable for triggering the association of its targeted ad with returned content, the advertising system will generate a payment block for the targeted ad. The payment block will correspond to the amount the advertiser paid and will be representative of the share that the advertiser is allocated based on the amount paid. The share percentage is calculated based on amount paid divided by the total amount paid by all sorted relevant ads. Therefore, before an advertiser's ad is stored on the advertising system for retrieval, it has already been paid for, thus eliminating click fraud. No matter how many fraudulent clicks might be made on such ad, the price paid by the advertiser for such ad will not change.

The present invention assesses the amount of ad space available for display of targeted ads at the end-user display space. Based on this assessment, there will be a determination of the appropriate number of ads that may be returned for display. As such, if a popular keyword or phrase is selected by a number of advertisers, the ordering of the targeted ads will be in the manner discussed above, but the system will only display the number of ads that are appropriate for the end-user display space. If there are more targeted ads than available space, some ads will not be sent. Therefore, ordering is very important because if an advertiser is number 6 in the order and the display space can only accommodate 5 ads, then the 6th advertiser will not have its targeted ad transmitted to the end-user for display.

The system and method of the present invention also provides the advertising system and advertisers with the ability to collect information about ad usage by content providers and by end-users. The system and method may further provide for the collection of ad selection information. These two types of information are made available to advertisers for considering the efficacy of certain targeted ads and the amount to pay for a share under the system of the present invention.

The system and method of the present invention also provides for the distribution of targeted advertisements and the distribution of revenue associated with target advertisements to content providers.

An object of the present invention is to provide a system and method for targeted advertising on media, such as the Internet and WWW, which is not susceptible to click fraud.

Another object of the present invention is to provide system and method for targeted advertising that is a pay per share system.

A further object of the present invention is to provide a system and method for targeted advertising that uses a payment block representative of shares of the pay per share system.

A still further object of the present invention is to provide a system and method for targeted advertising that provides statistics and data for advertisers to determine the effectiveness of their ad campaigns and the appropriateness of the amount to pay for targeted ads.

A yet further object of the present invention is to provide a system and method for targeted advertising that will permit distributing advertisements to other content providers and the distribution of advertising revenues to content providers.

These and other objects of the present invention will be described in detail in the remainder of the specification referring to the drawings.

### BRIEF DESCRIPTION OF THE DRAWING

FIG. 1A shows a representative block diagram of a first system configuration that can incorporate the system and method of the present invention.

FIG. 1B shows a flow diagram that is representative of the operation of the system shown in FIG. 1A as it relates to the present invention.

FIG. 1C shows a representative block diagram of a second system configuration that can incorporate the system method of the present invention.

FIG. 2 shows a representative detailed block diagram of an end-user system shown in FIG. 1A.

FIG. 3 shows a representative detailed block diagram of the advertising system shown in FIG. 1A.

FIG. 4 shows a representative flow diagram that is used by the system and method of the present invention for the selection and display of targeted ads based on end-user search queries.

FIG. 5 shows a representative flow diagram that is used by the system and method of the present invention for determining which targeted ads to select.

FIG. 6 shows a representative flow diagram that is used by the system and method of the present invention for selecting and ordering ads for display based on the amount paid by advertisers for each relevant targeted ad for association with a keyword or phrase and the probability that each advertiser will be selected based on the amount paid.

FIG. 7 shows a representative block diagram for the selection and ordering of ads when tier groupings of ads are used.

### DETAILED DESCRIPTION OF THE INVENTION

The present invention is a system and method that permit advertisers to be able to provide targeted advertising for association with content on media, such as the Internet or World Wide Web, in such a way that it is not susceptible to click fraud. The system and method of the present invention is directed to a “pay for share” method that provides for billing before the targeted advertisements are made available for selection for display.

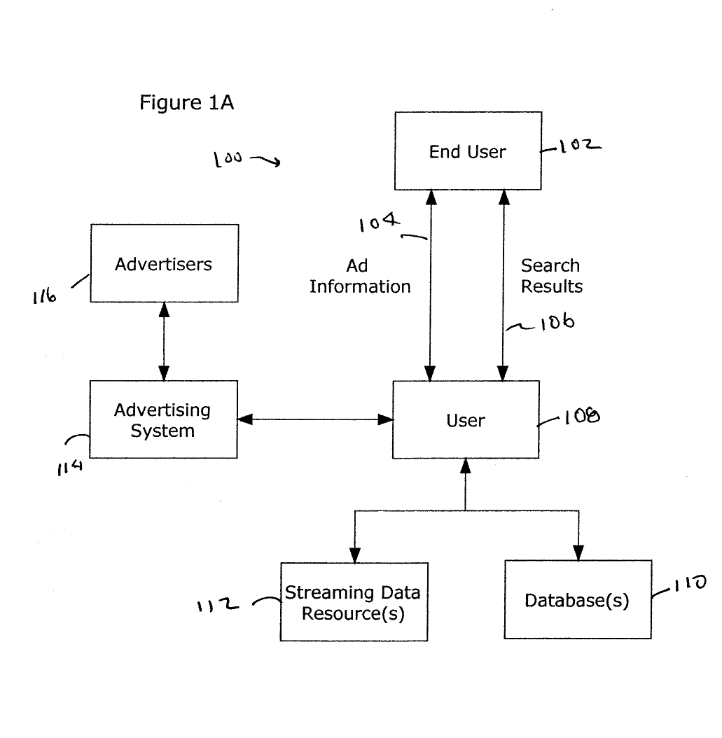

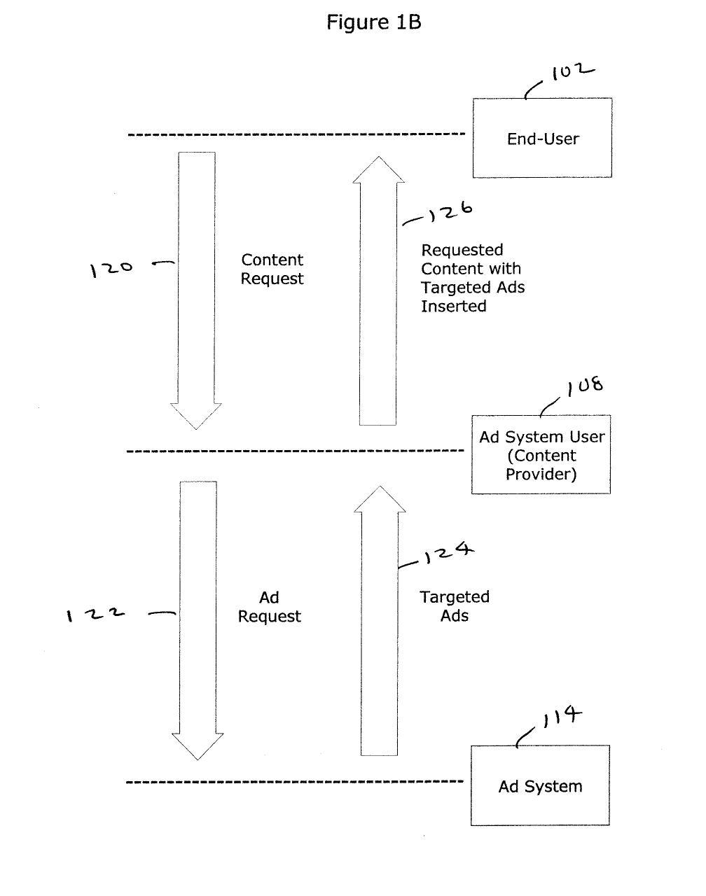

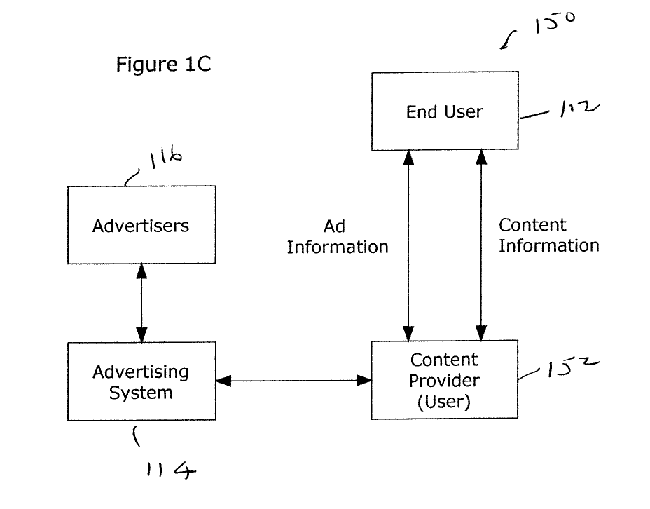

Referring to FIG. 1A, generally at 100, a representative block diagram of a system that can incorporate the system and method of the present invention is shown. Before describing the elements of the system shown in FIG. 1A, a general description of the operation of the system shown in FIG. 1A according to the present invention will be provided referring to FIG. 1B.

FIG. 1B shows a representative flow diagram of the operation of the system shown in FIG. 1A according to the present invention. This flow diagram relates to the way search queries, search results, and targeted ads are processed among end-users, ad system users (search engines or other content providers), and the advertising system. According to FIG. 1B, preferably, targeted ads are displayed at end-user 102 along side search results returned by search engine 108. However, it is understood that targeted ads may also be displayed alongside other forms of content provided by non-search-engine content providers and still be within the scope of the present invention. It is understood that such other forms of content provided by non-search engine content providers could include static or dynamic web pages, social networking content, video or television broadcasts, radio broadcasts, mobile device content, digital billboard displays, digital paper, or other forms of content. The selection, display, and ordering of these targeted ads is based on a “pay per share” selection method that is carried out according to the present invention using advertising system 114.

End-user 102 formulates and transmits content requests, in the form of search requests or queries, to search engine 108, as shown at 120. Based on the content requests, search engine 108 sends ad requests for targeted advertisements to advertising system 114. This is shown at 122. As shown in 124, advertising system 114 selects a set of targeted ads based on the ad requests and transmits these advertisements to search engine 108. The ads that are capable of being selected have already been paid for according to the pay per share system and method of the present invention. Search engine 108 transmits the requested content and the associated set of selected targeted ads to end-user 102 for display. This is shown at 126. These operations will be described in detail in remainder of the specification.

Again referring to FIG. 1A, an Internet- or WWW-based information search and retrieval system that has an advertising system associated with it would include User 108. Preferably, User 108 would be a search engine through which requested information could be retrieved and targeted advertising could be channeled. Unless specified differently herein, for purposes of the description of the present invention, User 108 will be referred to as search engine 108. However, it is understood by one skilled in the art that User 108 may be any apparatus, device, or system in hardware, software, firmware or combination thereof that will permit the retrieval of content and targeted advertisement associated with such retrieved content. For example, User 108 includes, but is not limited to, content sites, social network sites, electronic indoor and outdoor bulletin boards, or video distribution networks and systems.

Search engine 108 is connected to the database(s) 110 and streaming data source(s) 112. Database 110 as representative one or a plurality of storage devices or facilities. The information in these databases may be Web pages that are updated periodically. Streaming data source 112 represents one or a plurality of streaming data sources through which search engine 108 may request and receive dynamic real-time or near real-time information.

Referring to FIG. 1C, shown generally at 150, the system and method of the present invention will be described generally when User 108 is not a search engine. In FIG. 1C, the system includes end-user 102, advertising system 114, and advertisers 116 at set forth in FIG. 1A. However, in FIG. 1C, User 108 may be a content provider. Content providers include, but are not limited to, web site publishers, television broadcasters, radio broadcasters, digital billboard operators, digital paper publishers or automated telephone services. For purposes of describing FIG. 1C, User 108 will be referred to as content provider 152.

As shown in FIG. 1C, communications between end-user 102 and content provider 152 includes ad information and content information. The ad information that is communicated between content provider 152 and end-user 102 as described in FIG. 1A. The content information that is communicated between end-user 102 and content provider 152 would include, but not be limited to, text, audio, images, video, URLs, and reference information.

In operation, content provider 152 will contact advertising system 114 for the purpose of signing up to receive advertising, including targeted ads, from advertisers 116. Content providers 152 will establish an account with advertising system 114 for handling advertising transactions with the advertising system and advertisers. Advertising system 114 may permit revenue-sharing between advertisers 116 and content providers 152 based on ad information communicated to, and/or accessed by, end-user 102.

When requesting ads from the advertising system, the content provider may provide specific targeting variables for the advertising system to use, such as keywords, queries, user statistics, user demographics, other user information, or other targeting variables; or the content provider may request that the advertising system determine the appropriate targeting variables based on the content provided by the content provider.

The method by which content provider 152 manages its account with advertising system 114 and a method of revenue-sharing with advertisers 116 will now be described.

Content provider 152 may provide advertising system 114 with account deposit information so that payments from advertising system 114 to content provider 152 may be deposited automatically into the specified deposit account. A minimum payment amount may be required by advertising system 114 before payments are made, and the advertising system may wait for such minimum payment amount to be reached prior to making a payment to content provider 152.

Content provider 152 may provide advertising system 114 with requests for the types of ads it desires such as, for example, text-only ads, video ads, or audio ads; the specific locations for such ads to be displayed; and the number of ads to provide. A content provider may request ads through an interface operation. In such a case, the content provider could place HTML code within its web site that makes an automated request to ad serving operations through an ad interface. For example, the content provider web site may have imbedded codes, such as “Request 5 text-only ads from the Gigablast.com ad serving operations and display them here.”

Content provider 152 may also provide advertising system 114 with limitations on certain ads that should not be displayed, such as ads for beer and wine, ads related to certain keywords, or ads from certain competitors.

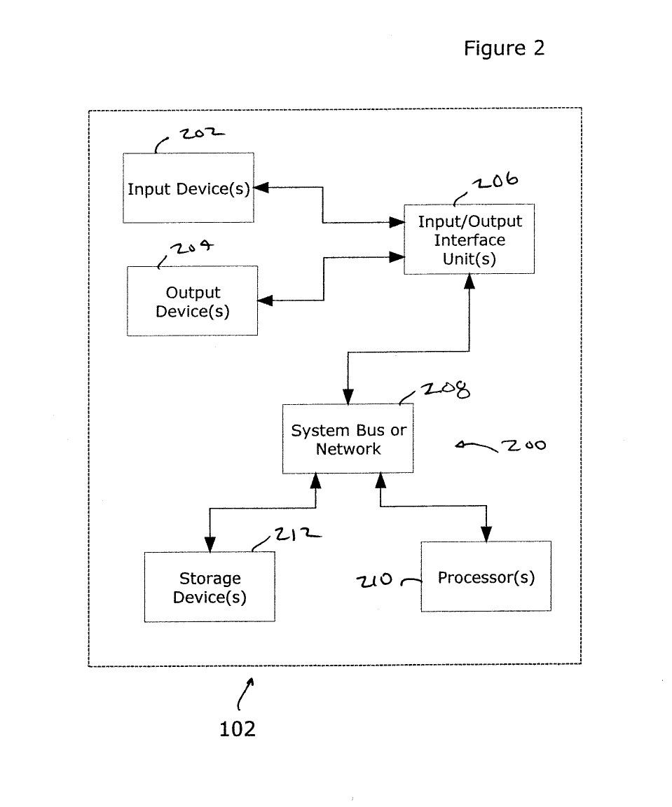

Again, referring to FIG. 1A, end-user 102 is representative of one or a large plurality of end-users that connect to Internet- or WWW-based search engine 108. End-user 102 will formulate search queries for content that are sent to search engine 108. Search engine 108 will process these queries and retrieve content from database 110 and/or streaming data source 112. The identified content is returned to end-user 102. The end-user search queries and retrieved content are transmitted on line 106 that is labeled “Search Results.” End-user 102 will be described in greater detail with reference to FIG. 2.

The relevant search results that search engine 108 provides end-user, for example from a stored index of Web pages, may be a list of Web page titles, snippets of text extracted from those Web pages, or hypertext links to those Web pages. The retrieved content may be grouped in any of a number of ways and still be within the scope of the present invention.

Search engine 108 also is in communications with advertising system 114. Advertising system 114 is in communications with advertisers 116. Advertisers 116 are representative of one or a plurality of advertisers that utilize the advertising system for providing targeted advertisements to end-user 102.

Advertising system 114 is representative of a system for advertising entry, management, and maintenance thereof, and the delivery of targeted advertising to end-users based on their search queries for content submitted to search engine 108. Advertisers 116 may directly or indirectly enter, manage, maintain, and track ad information using advertising system 114.

Targeted ads that are created by advertisers may be in the form of graphical ads, such as banner ads; text-only ads; image ads; audio ads; video ads; or combinations of one or more of these ad types. Targeted ads may also include embedded information, such as hyperlinks, metadata, and/or machine executable instructions. Once advertisers create ads, they are assembled by the advertising system according to its rules and communicated from advertising system 114 to search engine 108 based on end-user queries for content.

Search engine 108 sends ad requests for targeted ads or other types of ads to advertising system 114. The ads requests may include the search query, information-based on the query, information based on user behavior or user information, and/or information associated with, or based on, the search results. Ad requests may include the search query “as entered” or “parsed.” Further, the information in an ad request based on the search query may include user information, time and date information, or geolocation information. The information associated with search results may include, for example, identifiers related to the search results, indexing scores related to the search results, snippets of text extracted from identified documents, such as Web pages, full text of identified documents, or feature vectors of identified documents.

The advertising system will return targeted ads based on the ad requests. In one configuration, search engine 108 will provide usage information to advertising system 114. This usage information will relate to the ads that have been sent to search engine 108 and transmitted to end-user 102. The usage information transmitted back to advertising system 114 may include when, where, and how a targeted ad was rendered. This may include the position, whether or not there were any click-throughs, impression time, impression date, size, or whether there was any conversion of a sale based on the targeted ad. This usage information also may include measured or observed user behavior related to targeted ads that have been provided to end-user 102. An example of observed user behavior may include the number of times a particular end-user visited a particular targeted ad.

In a second configuration, advertising system 114 will be privy to all or part of the ad information relating to the targeted ads transmitted to end-user 102, and all or part of the usage information associated with such targeted ads. In such situations, search engine 108 may not need to transmit usage information back to advertising system 114 or at most just transmit some of usage information back to advertising system 114.

When search engine 108 submits a request for targeted ads to advertising system 114, the request may include the number of desired ads to be returned. This number may depend on the content of the search results, the amount of screen or paid space occupied by the search results, or the size and shape of the ads themselves. This is necessary so that the targeted ads will not obscure the content that is being sought by end-user 102 through his/her search query. For example, search engine 108 may request five targeted ads from the advertising system with regard to a particular keyword or phrase.

Search engine 108 will receive the requested number of ads for a particular keyword or phrase from advertising system 114 and combine those ads with the search results. This combination is provided to end-user 102. The ads that are provided to search engine 108 from advertising system 114 are provided to end-user 102 on line 104 labeled “Ad Information.” Preferably, ads are kept distinct from the search results, or otherwise marked in some fashion as advertisements, so the end-user does not confuse the targeted advertisements with the search results.

In discussing FIG. 1A, search engine 108 and advertising system 114 have been described as separate elements. However, it is understood that search engine 108 and advertising system 114 may be a single integrated unit and still be within the scope of the present invention. Further it is understood that database(s) 110 may be part of this integrated unit and still be within the scope of the present invention. Further, it is understood that search engine 108, advertising system 114, and database 110 may be implemented in hardware, software, firmware, or a combination thereof and still be within the scope of the present invention.

Referring to FIG. 2, end-user system 102 of FIG. 1A is shown in greater detail at 200. Each end-user 102 may be a unit such as personal computer with a keyboard and monitor, or a group of discrete elements that are connected to carry out the purpose of the present invention.

Input device 202 is for creating search queries for transmission to search engine 108. Input device 202 may be a keyboard or pointing device, such as a mouse. Other input devices include, but are not limited to, microphones, joysticks, game pad, satellite dishes, and scanners.

Output device 204 is for displaying the content of search results and retrieved targeted ads that are associated with the content. Output device 204 includes a display monitor or other type of device that can communicate search results to the person or entity that provided the search query. Examples of other output devices include, but are not limited to, speakers or printers.

Input device 202 and output device 204 are in communication with input/output (I/O) interface unit 206. I/O interface unit 206 processes information input from input device 202 and delivers information to output device 204.

I/O interface unit 206 is in communication with system bus or network 208. It is understood that the system bus or network could be wired or wireless and still be within the scope of the present invention.

System bus or network 208 connects to processor 210 and storage device 212. Processor 210 includes microprocessors in the case of personal computers, or processors to execute machine executable instructions when end-user 102 is composed of discrete elements.

Storage device 212 includes read-only memories (ROMs) and/or random access memories (RAMs) or other type of storage element when end-user 102 is a personal computer. If end-user 102 is composed of discrete elements, storage device 212 may be any type of conventional storage device, such as a hard disk, magnetic tape or disk, optical disk, or other storage media, and still be within the scope of the present invention.

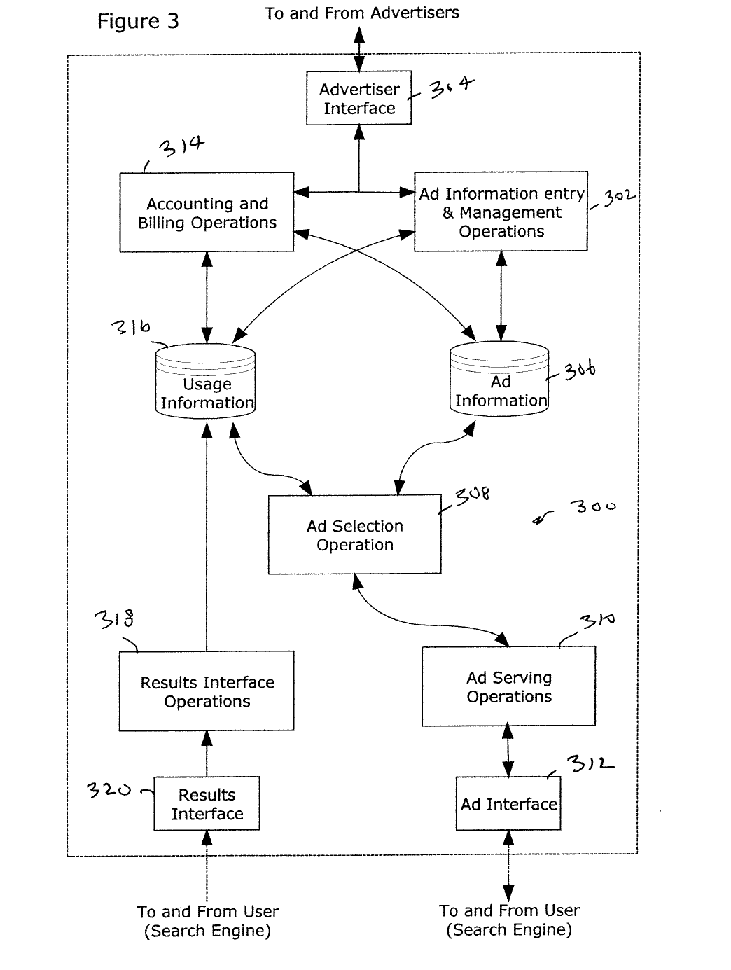

Referring to FIG. 3, generally at the 300, a detailed diagram of advertising system 114 (FIG. 1A) is shown. As previously stated, advertising system 114 is for entry, management, maintenance, and delivery of advertisements including targeted advertisements. More particularly, advertising system 114 may store end-user information, support accounting and billing operations, and provide for ad information entry and management, ad selection operations, ad serving operations, and results of interface operations. In referring to “operations” in FIG. 3, it is meant that such system elements may be a single defined device programmed for that particular purpose, a plurality of devices or systems programmed for that particular purpose, or integrated software or firmware that is programmed for that particular purpose.

Advertisers 116 have three interfaces. The first interface is advertising interface 304 that connects advertising system 114 to advertisers 116. This permits advertisers 116 to connect to ad information entry and management operations 302 and accounting and billing operations 314. Through advertising interface 304, advertisers can enter their accounts, ad campaigns, ads, creatives, and targeting information. Through this interface, advertisers 116 also can retrieve usage information to understand the effectiveness of their targeted ads.

The second interface is ad interface 312 that connects advertising system 114 to search engine 108. This second interface is used to receive ad requests transmitted from search engine 108 and transmit targeted ads selected by the advertising system based on these requests to search engine 108.

The third interface is results interface 320 that also connects advertising system 114 to search engine 108. Search engine 108 uses the third interface to communicate usage result information about targeted ads to advertising system 114. This information may include information to identify the ad, the time the ad was served, as well as result information about the ad. In discussing FIG. 3, ad interface 312 and results interface 320 have been described as separate elements. However, it is understood that ad interface 312 and results interface 320 may be a single integrated unit and still be within the scope of the present invention.

As stated, advertisers may enter accounts, ad campaigns, ads, creatives, and targeting at ad information entry and management operations 302 through advertiser interface 304. As used herein, these terms mean the following:

“Accounts” means information relating to a given advertiser, which may include, but not be limited to, an advertiser's unique e-mail address, password, account administrator information, billing and accounting information, or other pertinent advertiser information. However, if “Account” is used in the context of a content provider, it refers to an “account” as described with regard to FIG. 1C.

“Campaign” or “Ad Campaign” means one or more groups of one or more advertisements or groups of advertisements, which may include, but not be limited to, ad start date, ad end date, geo-targeting information, or syndication information.

For example, Tire Company C discussed above may have one advertising “campaign” for car tires and a separate advertising “campaign” for truck tires. The campaign for car tires may have one or more groups each containing one or more ads. Each ad group or individual ad may include one or more targeted keywords, queries, phrases, or concepts. Each ad group or individual ad may also include a payment amount or multiple payment amounts. There may be multiple payment amounts because payment amounts are associated with the keywords or phrases, and a given ad might contain multiple keywords or phrases.

“Creatives” means one or more ads of an ad group. Creatives form the ad content that is ultimately provided to end-users.

“Targeting” means the use of specific variables to identify specific advertisements for selection and display. For example, a 45 year-old end-user who is watching a television program on cars might see an advertisement for high-performance tires. This advertisement for tires is likely an advertisement targeted for viewers of driving-age who are watching television shows about cars. In this case, the variables used for “targeting” were the likely age of the viewer and the content of the television program.

When advertisers 116 input accounts, ad campaigns, ads, creatives, and targeting into advertising system 114 through advertiser interface 304, it is stored in ad information storage system 306. Ad information storage system 306 may store more or less information than described above, but what it does receive it will organize in any of various conventional ways, all of which are within the scope of the present invention.

Ad information from advertisers that is input to ad information entry and management operations 302 is also managed for each advertiser. The management operations performed by ad information entry and management operations 302 will be described subsequently.

Ad serving operations 310 of advertising system 114 communicates with search engine 108 (FIG. 1A) through ad interface 312. Ad serving operations 310 services requests for ads that are received from search engine 108. Ad serving operations 310 services the requests in the following manner.

Requests for ads are received from search engine 108 and processed by ad selection operation 308. The ads selected by ad selection operation 308 will be returned to ad serving operations 310. Ad serving operation 310 may process or format the ads prior to delivery to search engine 108 through ad interface 312. This processing or formatting may include the addition of XML tags, or the addition of reference information to the selected ads. For example, ad serving operations 310 might add tracking information to the selected ads' URLs, which might enable the ad serving operation to track usage statistics for the selected ads that are displayed at end-user 102.

Based on these ad requests, ad serving operations 310 will communicate with ad selection operation 308 for the selection of ads for transmission to search engine 108. The ad selection process will be subsequently described in detail.

Results interface operations 318 is in communication with search engine 108 through results interface 320. Results interface operation 318 may be used for accepting results information about ads actually served to end-users 102. This results information may include, but not be limited to, whether or not click-throughs occurred and whether or not conversions occurred. With regard to conversion, it means whether a sale of an advertised item or service was initiated or consummated within a predetermined time once the targeted ad was rendered. The results information that is received by results interface operations 318 may be stored in usage information storage system 316.

Ad selection operation 308 is connected to ad information storage system 306 and usage information storage system 316. The ad selection operation will retrieve relevant targeted ads from ad information storage system 306 based on the ad requests from search engine 108. When targeted ads are selected using ad selection operations 308, information about the selected ads is transmitted to, and stored in, usage information storage system 316. The information that is transmitted may include, but is not limited to, the total ads considered, the number of ads requested, the ads that were selected, the order in which those selected ads appeared, timing information (time of day, day of week, month, year, for example), and information relating to the requesting search engine or content provider.

As will be discussed subsequently, some or all of the usage information that is stored in usage information storage system 316 for a particular advertiser may be transmitted to ad information entry and management operations 302 or accounting and billing operation 314 for transmission to, or access by, the appropriate advertisers 116 through advertiser interface 304.

As shown in FIG. 3, accounting and billing operations 314 is connected to ad information storage system 306 and usage information storage system 316. According to the system and method of the present invention, the information from these two storage systems is used for billing and accounting purposes as it relates to particular advertisers that are using the advertising system. The accounting and billing operations process will be described subsequently.

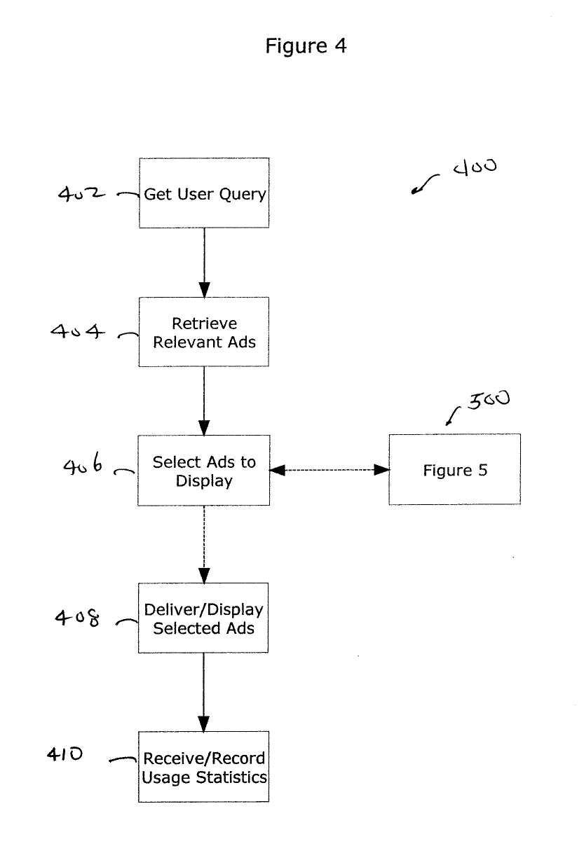

Referring to FIGS. 4, 5, 6, and 7, operation of the system shown to FIG. 1A will now be described according to the novel features of the present invention.

Referring to FIG. 4, generally at 400, a flow diagram is shown that is representative of the method used by the present invention for the selection and display of targeted ads based on end-users search queries. End-user 102 (FIG. 1A) submits a search query for content to search engine 108. Prior to this, advertisers 116 will have submitted to advertising system 114 targeted ads, paid for keywords and phrases, or other targeting variables that will trigger the association of these targeted ads with content of search results.

At step 402 in FIG. 4, the end-user search query that has been received by the search engine is transmitted in the form of an ad request from search engine 108 to advertising system 114. Ad serving operations 310 receives the ad request and processes it. Ad serving operations 310 then sends a request for relevant ads to ad selection operation 308.

At step 404, ad selection operations 308 retrieves the relevant ads from ad information storage system 306 based on matching keywords or phrases with elements of the search query. Of the ads that are retrieved from ad information storage system 306, only a predetermined number of these ads will be transmitted back to search engine 108 based on the selection process carried out according to the present invention. The selection of ads to be transmitted back is carried out at step 406.

At step 408, the predetermined number of targeted ads that have been selected and transmitted to search engine 108 are delivered (transmitted) to end-user 102 where they are displayed. At step 410, relevant usage statistics and information relating to the selected ads that were transmitted to end-user 102 is transmitted from ad selection operation 308 to usage information storage system 316 for storage and access by advertisers.

Again referring to step 404, the method of retrieving relevant targeted ads will be described. Targeted advertisements may be based on a number of different variables. As previously mentioned, targeting variables may include keywords or phrases, search queries or phrases, concepts or user statistics or behaviors. According to preferred embodiment of the present invention, the targeting variable is an end-user search query transmitted to search engine 108, and such search query includes one or more words. It is understood by a person of ordinary skill in the art that each individual word within a search query may be referred to as a “keyword.” It is also understood that the total number of search queries that an advertiser may associate with a given advertisement may be limited or unlimited.

According to the present invention, relevant targeted ads that may be retrieved by the advertising system may be determined by series of comparisons between the search query and the advertisers' targeting keywords or phrases for each ad. The selection process is carried out at ad selection operations 308.

In ad selection operations 308 performing the above reference comparison at step 406, the search query received from search engine 108 is broken down into a list of words and phrases. These words and phrases are compared with an index containing the full set of an advertisers' selected targeted keywords and phrases for all of the advertisements entered into advertising system 114. From this comparison, a list of advertisements containing matching keywords and phrases is generated. This list forms the relevant ads that are retrieved.

An advertiser may not only program positive matches of keywords or phrases but may also program negative keywords or phrases be associated with a particular advertisement. In this case, the negative keyword or phrase will prevent a targeted ad from being selected if there is a match with the negative keyword or phrase. As an example, an eyeglass retailer who desires its ad to be displayed when an end-user enters the search query “glasses” may not want its ad displayed if the user enters the search query “wine glasses.” In this latter situation, the advertiser may select the keyword “wine” as a negative keyword to prevent its ad from being selected for display if there is a match with the search query.

The present invention also contemplates other filtering methods may be used in the retrieval of relevant ads to be returned to the end-user. If an advertiser specifies an exact match for the selection of targeted advertising, the end-user search query must contain the exact set of words in the exact order as the targeted keywords or phrases. If this exact match is not found, the advertisement will be filtered out and not returned for display. Other filtering that is possible according to the system and method of the present invention includes, but is not limited to, phrase matching and spam filtering.

Filtering may also be based on a trust or quality factor assigned to each advertiser. For example, if the usage information evidences a large degree of negative consumer feedback, the advertiser that owns the targeted ad may be filtered out by advertising system 114 and prevented from entering any new ads into the system. It is further understood, that ads submitted by an advertiser may be promoted or demoted during the ad selection process based on such a trust or quality factor and it will still be within the scope of the present invention.

After retrieving the relevant ads as described, statistics may be recorded and stored for analysis by advertising system 114, which may be transmitted to, and provide for access by, advertisers to whom these statistics apply. These statistics are transmitted from ad selection operation 308 to usage information storage system 316 for storage and access by advertisers.

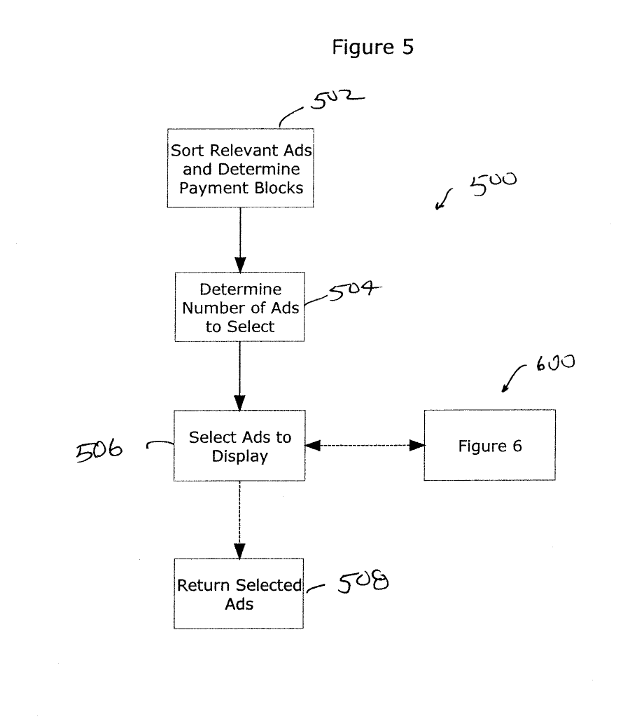

Referring to FIG. 4, once relevant ads are retrieved at step 404, the system and method of the present invention carries out ad selection for display at end-user 102. As shown in FIG. 4, ad selection is carried out at step 406, which is shown in greater detail in FIG. 5, generally at 500.

Referring to FIG. 5 at step 502, the relevant ads that have been retrieved by ad selection operations 308 (FIG. 3) from ad information storage system 306 are sorted by ad selection operations 308, preferably, based on the amount that each advertiser paid for its ad to be associated with a particular targeted keyword or phrase. Sorting, however, is probability-based according to the number of shares a particular advertiser has paid for. Therefore, as will be shown, if there were three advertisers that all sought to associate their ads with a particular keyword or phase, and Advertiser #1 paid $3.00, which was ½ of the shares, Advertiser #2 paid $2.00, which was ⅓ of the shares, and Advertiser #3 paid $1.00, which was ⅙ of the shares, based on probability, over a reasonable period of time, ½ of the time Advertiser #1 would be listed first. It is also seen that if one of the other advertiser were listed first then the probability that Advertiser #1 would be listed second is very high compared to the other remaining advertisers given Advertiser #1's share value. For purpose of describing the Tables 1 and 2 below, ordering will be assumed according to the share amount, with the largest being first.

For each ad entered into advertising system 114 and paid for by an advertiser, ad information entry and management operations 302 generates a payment block corresponding to the amount paid for the targeted keyword or phrase. The following is an example of the ordering and information generated and stored by advertising system 114 for ads associated with a particular targeted keyword or phrase.

If there were three ads in advertising system 114 in which there is match between the end-user search query and the targeted keyword or phrases, and three advertisers paid payment amounts are $3.00, $2.00, and $1.00, respectively, the ads may be sorted as shown in Table 1. The payment block that is associated with each payment is calculated based on each ad payment amount in relation to the total amount paid for all retrieved relevant ads:

TABLE 1

| Ad Number | Payment | Payment block |
|---|---|---|
| 1 | $3.00 | $3.01-$6.00 |
| 2 | $2.00 | $1.01-$3.00 |
| 3 | $1.00 | $0.01-$1.00 |

According to Table 1, when these ads are displayed at end-user 102 associated with the content based on the search query, the targeted ads will be in the order shown in Table 1. If an advertiser desires to improve the ordering of its ad, it would have to pay more than one of the other advertisers above it to increase its chances of being selected higher in the ordering for display.

The system and method of the present invention also contemplates that advertisers may select keywords or phrases for associating their targeted ads with content but without paying for it. These advertisers would enter ad information as described but the payment amount would be $0.00. Advertising system 114 can be configured to accept any number of free ads or not accept these types of ads. However, if they are accepted, there is still the necessity of associating a payment block with these ads, but in a way that will not significantly diminish the value of advertisers that have paid for their ads. In such a situation, the advertising system will assign a nominal value to the payment blocks of ads of advertisers that did not pay. An example of such a condition is shown in Table 2, where non-paid, or free, ads are added to the list of paid ads shown in Table 1.

TABLE 2

| Ad Number | Payment | Payment block |
|---|---|---|
| 1 | $3.00 | $3.03-$6.02 |
| 2 | $2.00 | $1.03-$3.02 |
| 3 | $1.00 | $0.03-$1.02 |
| 4 | $0.00 | $0.02-$0.02 |
| 5 | $0.00 | $0.01-$0.01 |

As shown in Table 2, advertisers with ads at numbers 4 and 5 did not pay for those ads and have been assigned a nominal value of $0.01 in the payment block. Each of the advertisers that paid value for their ads, namely at ad numbers 1, 2, and 3, have had their payment blocks incremented to reflect the amount assigned to the payment blocks of the advertisers that do not pay. This method retains the share value for the paying advertisers.

Again referring to FIG. 5, once the retrieved ads are sorted and the payment blocks are generated, then at step 504, there is a determination of the number of ads to select for transmission to search engine 108 and ultimately end-user 102. This number may be a fixed number that is input to the advertising system 114 or dynamically determined by the advertising system based on a number of factors. These factors include, but are not limited to, specific search requests received by the advertising system from the search engine, timing information, such as time of day, day of the week, or size or length of the selected ads.

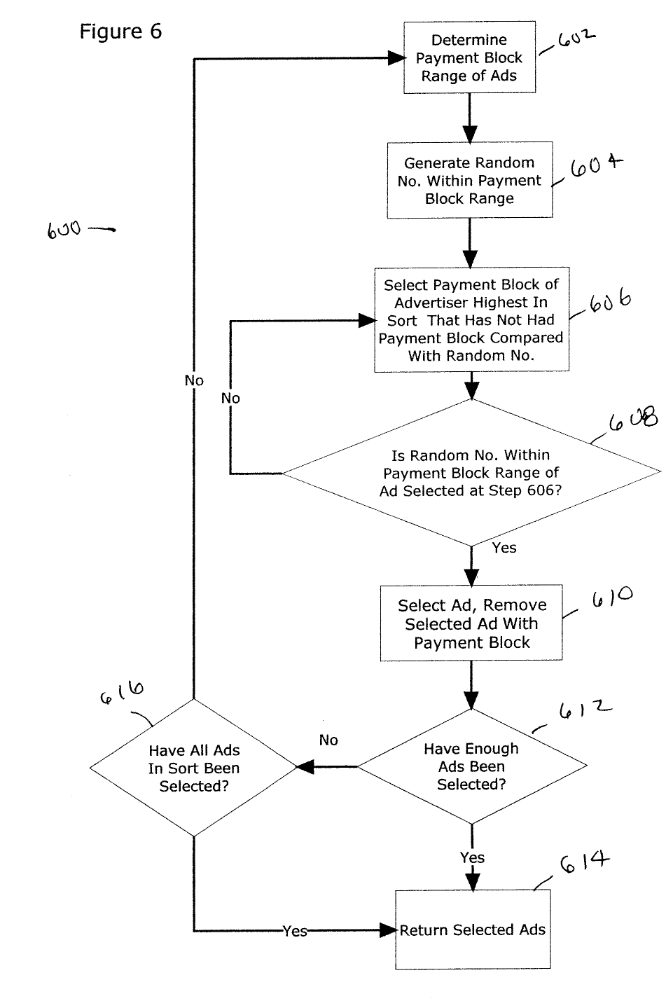

After the number of ads to select at step 504 is completed at step 506, ad selection operation 308 will select the ads to transmit for display. This process will be explained in greater detail with regard to FIG. 6 shown generally at 600. However, once the ad selection for display is made at step 506, the system and method of the present invention will proceed to step 508 to return the selected ads to search engine 108 for transmission to end-user 102 for display with the appropriate content.

FIG. 6, generally at 600, shows a method by which ads are selected for return to search engine 108 for display at end-user 102. The method of FIG. 6 will be described in view of Tables 3 and 4 below:

TABLE 3

| Advertiser | Payment | Payment block |
|---|---|---|
| Advertiser #1 Ad | $3.00 | $3.01-$6.00 |
| Advertiser #2 Ad | $1.20 | $1.81-$3.00 |
| Advertiser #3 Ad | $0.90 | $0.91-$1.80 |
| Advertiser #4 Ad | $0.30 | $0.61-$0.90 |
| Advertiser #5 Ad | $0.24 | $0.37-$0.60 |
| Advertiser #6 Ad | $0.18 | $0.19-$0.36 |
| Advertiser #7 Ad | $0.12 | $0.07-$0.18 |
| Advertiser #8 Ad | $0.06 | $0.01-$0.06 |

After the number of ads to be returned has been determined at step 504 in FIG. 5, at step 602, there is a determination of the payment block range of the sorted ads. In Table 3 above, this range is $0.01-$6.00.

At step 604, ad selection operation 308 generates a random number within the payment block range determined at step 602. For example, the random number generated may be $2.23. This will be used for determining the first ad selected for return to search engine 108.

At step 606, ad selection operation 308 will select the highest advertiser payment block in the sort that has not had its payment block compared with the random number that was generated. Again referring to Table 3, since this is the beginning of the selection process, the payment block for the Advertiser #1 Ad would be the first selected for comparison.

At step 608, the random number $2.23 is compared with the payment block of the Advertiser #1 Ad. This comparison would determine that the random number is not within the range of the payment block of the Advertiser #1 Ad and the selection process will return to step 606 to increment to the next payment block in the sort that has not been compared with the random number that has been generated.

The next payment block in the sort is the payment block of the Advertiser #2 Ad. The selection process moves to step 608 where there is a comparison between the random number and the payment block of the Advertiser #2 Ad. This comparison would determine that the random number is within the range of the payment block of the Advertiser #2 Ad.

Next, ad selection operation 308 will move to step 610. At step 610, since there was a match at step 608, the Advertiser #2 Ad will be selected and along with its payment block will be removed for later transmission to search engine 108 as the first ad to be displayed at end-user 102.

At step 612, ad selection operation 308 will determine if enough ads have been selected to equal the number of ads to be returned according to step 504 (FIG. 5). If by way of example, the number of ads to be returned is 3, then the process will move to step 616 since only one of the three requested ads have been selected.

At step 616, ad selection operation 308 determines if all of the ads in the sort have been selected. If all have been selected, it will mean that whether or not the criterion of step 612 has been met, there are no additional ads that can be selected so the process will move to step 614. At step 614, all of the selected ads will be returned to search engine 108 even though less ads than the number authorized at step 504 have been selected.

Again referring to step 616, if all of the ads in the sort have not been selected, ad selection operation 308 will return to step 602. At step 602, there will be new determination of the payment block range but this time it will be determined without the inclusion of the payment block values for the Advertiser #2 Ad. This new payment block range amount will be $0.01-$4.80. The payment blocks for the advertiser ads that remain are shown in Table 4:

TABLE 4

| Advertiser | Payment | Payment block |
|---|---|---|
| Advertiser #1 Ad | $3.00 | $1.81-$4.80 |
| Advertiser #3 Ad | $0.90 | $0.91-$1.80 |
| Advertiser #4 Ad | $0.30 | $0.61-$0.90 |
| Advertiser #5 Ad | $0.24 | $0.37-$0.60 |
| Advertiser #6 Ad | $0.18 | $0.19-$0.36 |
| Advertiser #7 Ad | $0.12 | $0.07-$0.18 |
| Advertiser #8 Ad | $0.06 | $0.01-$0.06 |

Given the remaining ads of the sort as listed in Table 4, the process of ad selection operation 308 will be repeated according to steps 602, 606, 608, 610, 612, and 616 until either the conditions of step 612 or 616 are satisfied, and the selected ads are returned to search engine 108 at step 614. The order in which the ads will be displayed at end-user 102 will be according to their order of selection. That is, the ad selected first will be the first displayed first, the ad selected second will be displayed second, and so on.

As would be understood, the likelihood of an ad being selected to be the first in the order for display at end-user 102 is increased statistically by the greater number of shares that has been paid for since selection is based on a randomly generated number. However, ordering is not guaranteed based on the number of shares paid for as was shown in the example above in describing the selection process relating to Tables 3 and 4 above.

Preferably, the relevant ads in a sort will be grouped by the quality of the match between the keywords and phrases and the search query. For example, targeted ads that contain an exact match may be grouped in a first tier of ads. Targeted ads that contain a matching phrase, i.e., two or more words in the correct order, may be grouped in a second tier. Finally, targeted ads that match only words in no particular order may be grouped in a third tier.

As an example of quality matched according to the present invention, grouping according to the three tiers will be described with regard to the search query “studded snow tires.” The first tier will include targeted ads that have the targeted key phrase that exactly matches the search query (“studded snow tires”). The second tier will include targeted ads that have matching phrases consisting of two or more words in the same order as those found in the search query. This may include targeted key phrases such as “snow tires” or “studded snow.” The third tier will include targeted ads that have keywords that match words of the search query by but not in any particular order. This would include matches such as “tires,” or “studded tires,” or “tires snow” or synonym analysis such that “tires” might be queried to “wheels.”

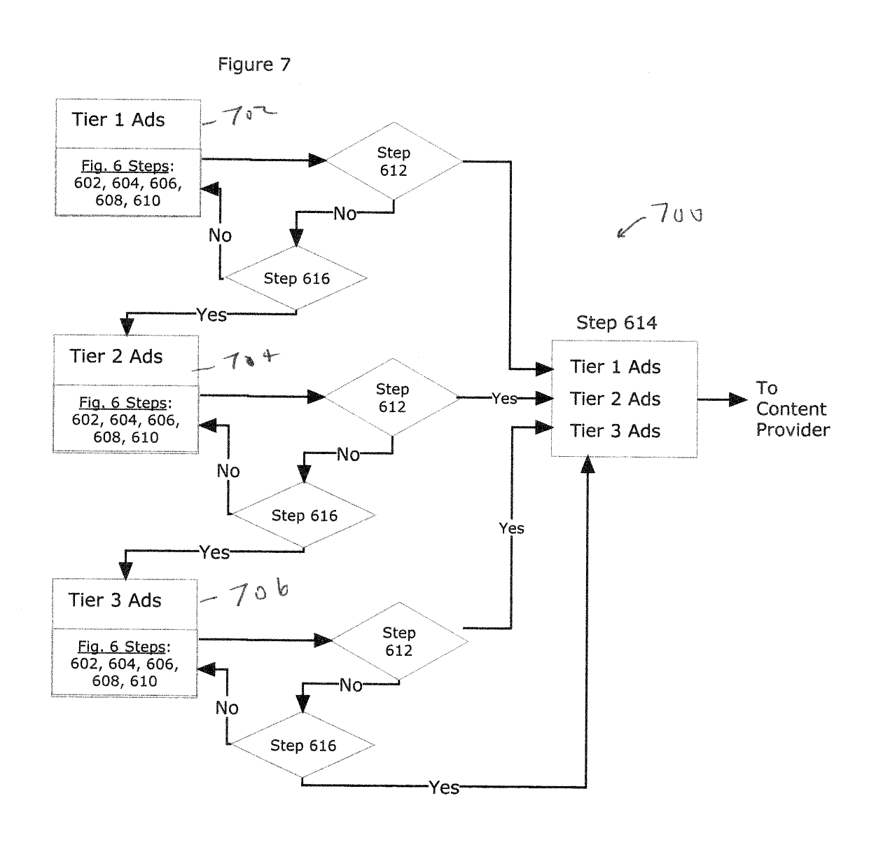

After the above tier groupings are determined, the system would order the targeted ads in each tier by the method described above according to the present invention. Referring to FIG. 7, generally at 700, the method of selecting advertisements for transmission to the content provider will be described for tier groupings of advertisements.

As shown in FIG. 7 at 702, 704, and 706, within each tier, the ad selection steps 602, 604, 606, 608, 610, and 616 of FIG. 6 will be used for selecting ads. At 702, the ad selection steps of FIG. 6 will first be used for selecting advertisements in the first tier: advertisement with exact matches. When the ad selection steps of FIG. 6 progress to step 612, there is a decision whether the conditions of this step are met. If they are met, the selected ads are sent to step 614 for transmission to the content provider, and the ads in the second and third tiers will not be considered.

If the conditions of step 612 are not met but the conditions of step 616 are met, the ad selection steps of FIG. 6 will then be used at 704 for selecting ads in the second tier: ads with phrase matches. If the conditions of step 612 are met during the selection process according to the FIG. 6 steps shown at 704, the selected tier two ads will be sent to step 614 and the ads in the third tier will not be considered. Advertisements selected within the second tier will appear following the advertisements selected from the first tier as shown in FIG. 7 at step 614.

If the conditions of step 612 are not met but the conditions of step 616 are met, the ad selection steps of FIG. 6 will then be used as shown in step 706 for selecting ads in the third tier: partial matches. The ads selected from the third tier will appear after any ads selected from the first tier and second tier as shown in FIG. 7 at step 614. Additionally, within each tiered grouping, additional sub-tiers may be used. For example, ads that have three matching keywords might be in a sub-tier distinct from ads that merely have two matching keywords.

It is understood by one skilled in the art that advertising groups may be used in place of advertisements in the methods described above, and that the ad selection method of FIG. 6 may select advertising groups instead of individual ads. If advertising groups are selected, then step 614 may include the select individual advertisements within selected advertising groups. For example, an advertiser may pay for an ad group that contains three advertisements, each with slightly different creative content. An advertiser may apply weightings to each of the three advertisement, and steps 614 may use these weighting to determine which of the three advertisements to display when the advertising group has been selected for display. These weightings might also be adjusted by the present invention based on ad usage information, such that advertisement with higher click-through rates or conversion rates receive larger weightings.

In another alternative embodiment of the invention, the ads may be sorted into groups. The first group may be paid ads and the second group may be the non-paid or free ads. According to this alternative embodiment, a predetermined number of paid ads will be selected following the method of FIG. 6 and the number of free ads would be separately selected following this method. The two selected sets may be the combined to reach the predetermined number of ads to be returned to search engine 108 and ultimately to end-user 102. If the combined number exceeds the number for transmitting ads back to search engine 108, then a certain number of nonpaying ads will not be selected for return.

Referring to FIG. 4 at step 408, once the selection process is completed according to the rules for advertising system 114, the selected set of ads are transmitted to search engine 108. Search engine 108 will then transmit the selected targeted ads to end-user 102. Preferably, the order in which the selected ads are displayed will correspond to the order in which they were selected at step 406. It is within the scope of the present invention that the selected ads may be delivered to one or more other end-users, such as in a broadcast method.

Again referring to FIG. 4, after step 408 is complete and the selected ads are transmitted to end-user 102, there is a collection of statistics and information associated with the ads at step 410. The statistics and information that are gathered will relate to the list of relevant ads that were retrieved, the list of sorted ads, and/or the list of selected ads that took place at ad selection operation 308. These statistics and information will be transmitted to usage information storage system 316 for storage. Advertising system 114 will perform an analysis of the statistics and information and these statistics and information also may be used for ad management purposes.

Statistics and usage data may be collected by search engine 108. This includes, but is not limited to, how the selected ads were displayed and/or used by search engine 108 and/or end-users 102. More specifically, statistics and usage data that may be collected could be (i) whether a particular ad that has been selected and displayed has been clicked-through by the end-user, and/or (ii) any actions taken following the click-through. Other statistics and usage data that may be collected and stored includes, but is not limited to, the display order of ads, the number of clicks or impressions based on display order, display appearance, or time of day popularity for clicking-through.

Again referring to FIG. 3, advertisers 116 can manage their ad campaigns through ad information entry and management operations 302 and their accounts through accounting and billing operations 314. Advertisers access each of these operations through advertiser interface 304.

Advertisers 116 may create one or more ad campaigns and transmit them to ad information entry and management operations 302. An ad campaign may include one or more ad groups or ads. For each ad group or ad that an advertiser may create, it may include, but not be limited to, creative content; Web page link information, such as a URL; various display control parameters, such as specific time periods for days that the ad may be displayed or may not be displayed or specific geographic regions in which the ad may or may not be displayed; desired targeting variables, such as keywords or phrases, queries, concepts, content, context, user statistics, or user information; or desired and negative targeting variables, such as targeting variables that may prevent the ad from displaying.

Advertisers 116 also must specify a payment amount for each targeting variable. This amount may be $0.00, for free ads, or a monetary value, such as $3.25, for paid ads.

In an alternative embodiment, advertisers may purchase ownership shares in desired targeting variables. In this case, it is intended that there be a finite, limited number of shares, e.g., 100, for each targeting variable. The ratio of shares owned divided by the total number of shares will determine the ad selection ordering priority for the display of targeted ads with content. By there being a finite, limited number of shares for a specific targeting variable, these shares may be bought, sold, and traded among advertisers in a clearing house or exchange system.

Advertising system 114 may provide advertisers 116 statistics and information during ad configuration at ad information entry and management operations 302. These statistics and information may be obtained by advertisers 116 by retrieval of same from ad information storage system 306 and/or usage information storage system 316. An example of information that may be obtained by an advertiser is the total amount of all payments from all advertisers for a specific targeting variable. This may help an advertiser determine the parameters by which it will develop and manage an ad campaign. This information may be displayed in numerical form or a graphical way.

The system and method of the present invention as implemented using advertising system 114 may allow the advertiser to select or exclude specific environments in which to have its targeted ads displayed. As such, advertising system 114 may enable an advertiser to choose specific web sites on which its ads would appear, or prevent certain web sites from displaying its ads. The advertiser might also choose from categories or groupings of web sites, where such categories could be based on various factors including, but not limited to, unique visitors, repeat visitors, language, country, or total advertising market per web site. Further, the advertiser might choose from other environments for display advertising, including billboards, television, mobile devices, radio, and further subcategories could exist within each of these advertising environments. This ability to select or exclude specific or categorically grouped environments may provide a micro-targeting capability for the advertiser and its targeted ads.

The system and method of the present invention as implemented using advertising system 114 may require a review period for the created ads prior to engaging the ads in the ad selection and display process. This review period could include manual or automated forms of review. The advertising system may use an automated system, such as Amazon's Mechanical Turk (http://www.mturk.com/mtuk/welcome), for presenting the ad to a number of human judges for review, where each judge would vote on the quality of the ad. The sum of the quality votes could be used to determine whether an ad is approved or disapproved, though an appeal process may be provided by advertising system 114. This ad review process might also be used to determine the trust factor or quality of specific ads.

A system and method of the present invention as implemented using advertising system 114 may include access controls with regard to statistics and information that an advertiser may obtain with regard to statistics and information of other advertisers, but it may be limited. This information will also assist in managing ad campaign. This information may be stored at ad information storage system 306 and/or usage information storage system 316. Taking the example above, the advertising system may permit an advertiser to obtain the total amount of payments of all advertisers for specific targeting variable but not another advertiser's advertising history.

Again referring to FIG. 3, advertiser interface 304 connects advertiser 116 to accounting and billing operations 314. Account and billing operations 314 enables advertiser 116 to log into the system, maintain payment accounts, view current or historical invoices, add or change account administrator information, set budget targets or limits, set account alerts, or terminate their account. Preferably, an initial minimum payment may be required from an advertiser during account setup and creation.

Once an ad campaign has been created at ad information entry and management operations 302, it may not become effective until advertiser 116 makes the appropriate payment to advertising system 114. Payment is considered made when (i) actually received by the advertising system or (ii) the advertising system accepts a free ad with a payment amount of $0.00 or (iii) an advertiser agrees to be invoiced for the payment amount. Once this payment has been made, the ad campaign information may be stored in ad information storage system 306 for retrieval when an end-user search query contains the advertiser's keyword or phrase (or other targeting variable).

In the preferred embodiment of the present invention, advertising system 114 will set a predetermined period of time within which payment for an ad campaign must be made before the system stores such ad campaign information in ad information storage system 306 for retrieval. For example, advertising system 114 may provide that payments received in the previous thirty (30) days will be considered as appropriate for storing ad information in ad information storage system 306 for retrieval. It is understood that more or less than thirty (30) days may be used and still be within the scope of the present invention. If that period has past for which an advertiser has paid for an ad, advertising system 114 may treat this ad as a free ad until the advertiser pays more for it or the system may drop the ad altogether.

Again referring to FIG. 3, advertisers 116 may desire usage information from usage information storage system 316 for assisting in making decisions regarding ad campaigns. Advertisers may obtain user information, ad displays statistics, or content provider statistics from ad information entry and management operations 302. According to the present invention, user information may include any information collected about end-user 102 that has viewed, selected, and displayed ads received through search engine 108, such as demographic information, geographic information, behavioral information, or other information related to users. Similarly, ad display statistics may include, but not be limited to, the number of times and/or percentages of time a particular ad matched a particular search keyword or search query, the number of times and/or percentage of time an ad was selected for display, the number of times and/or percentage of time an ad appeared in a particular position when displayed, the number of times and/or percentage of time an ad was clicked-through by a user and the associated position information.

As stated, advertisers may desire to retrieve statistics and information for creating an ad campaign and making decisions. This information may be retrieved from ad information storage system 306 and/or usage information storage system 316.

Advertisers 116 may also want specific information about each of their current or potential targeting keywords or phrases (or other targeting variables) for a given ad or ad campaign. Ad information entry and management operations 302 will provide to the advertiser historical payment information, current payment information, projected information, total payment information, or percentage payment information. Ad information entry and management operations 302 may also provide tools to help advertisers 116 select appropriate targeting keywords or phrases based on aggregate information from other advertisers, typical or historical end-user searching activity, or other means. All this information may be obtained from ad information storage system 306 and/or usage information storage system 316. When referring to percentage payment information, it means a percent of the total payments for all advertisers for the specified targeting variable requested by the advertiser's payment. All of this information will then provide the advertiser with a context by which ad campaign decisions may be made.

Another feature of the present invention is that content providers, such as publishers, broadcasters, web sites, search engines, or other parties who desire to display advertisements selected by advertising system 114, may subscribe to the advertising system to receive advertisements. Revenue generated from the advertisers may be distributed by the advertising system to the content providers in a predetermined manner. In the preferred embodiment, revenue is allocated according to the advertisers' ad targeting preferences. For example, if a particular web site has been selected by a majority of advertisers for display of ads, that web site operator may receive a majority of the shared revenue allocation.

In an alternate embodiment, the advertising system may allocate revenue based on various factors related to the content providers, including traffic volume, traffic quality, ad click rates, or ad display rates.

The terms and expressions that are used herein are meant for description not limitation. It being recognized that there may be minor changes or modifications that must take place and be within the scope of the present invention.

1. A system for associating advertisements with content retrieved by a content provider, comprising:
an end-user having an end-user device for generating content requests and receiving content from the content provider based on the content requests, and displaying content received from the content provider and advertisements associated with the content received from the content provider;
the content provider being capable of receiving content requests from the end-user device and retrieving content from at least content provider storage means based on content requests, and providing retrieved content to the end-user device for display, and being capable of generating ad requests with elements capable of being matched and transmitting the ad requests to an advertising system and receiving advertisements from the advertising system based on the ad requests for association with the content that has been retrieved, and transmitting the received advertisements to the end-user device for display associated with the retrieved content;
an advertising system for receiving at least one ad request from the content provider for advertisements for association with retrieved content and selecting advertisements for transmission to the content provider based on matching at least one keyword that will trigger selection of one or more advertisements accessible by the advertising system with at least one element of the ad request, with the advertising system ordering the selected advertisements for transmission to the content provider based on a ranking according to a probability of each selected advertisement being picked based on a share value range assigned each advertisement according to an amount paid for the keyword being compared to a random number generated by the advertising system, and further with the advertising system making the advertisements available for selection only after the advertising system determines the amount paid for the keyword has been made; and
one or more advertisers that provide advertisements to the advertising system and pay an amount for a keyword for matching with at least one element of the ad request for triggering selection of each respective advertiser's advertisement for possible association with the content retrieved by a content provider.

2. The system as recited in claim 1, wherein the content provider includes a search engine.

3. The system as recited in claim 1, wherein the end-user device includes a computer.

4. The system as recited in claim 1, wherein the content provider collects information relating to the end-user accessing the advertisements displayed on the end-user device.

5. The system as recited in claim 1, wherein the advertising system collects information relating to the end-user accessing advertisements displayed on the end-user device.

6. The system as recited in claim 1, wherein the keyword includes keywords and phrases.

7. The system as recited in claim 6, wherein matching includes an exact match.

8. The system as recited in claim 6, wherein matching includes matching two or more keywords in a same order.

9. The system as recited in claim 6, wherein matching includes one or more keywords or phrases.

10. The system as recited in claim 1, wherein the system includes a pay per share system.

11. The system as recited in claim 1, wherein a share value range for each advertisement includes a range being determined by an amount paid by an advertiser for a keyword in relation to a total amount paid for advertisements selected based on the keyword.

12. The system as recited in claim 11, wherein the total amount paid for advertisements selected based on a keyword is a total value range.

13. The system as recited in claim 12, wherein the advertising system generates the random number within the total value range for comparison with the assigned shared value range for the selected advertisements for the selection of at least one advertisement for transmission to the content provider.

14. A method for associating advertisements with content retrieved by a content provider, comprising the steps of:
(a) generating at an end-user a content request for a content provider to retrieve content based on the content request, and transmitting the content request to the content provider;
(b) the end-user receiving content from the content provider based on the content request;
(c) the content provider transmitting ad requests based on the content request to an advertising system with the ad requests including elements capable of being matched;
(d) the advertising system selecting and ordering advertisements for transmission to the content provider based on the ad requests according to the following substeps,
(1) determining the elements of the ad request capable of being matched,
(2) determining each keyword that each advertiser paid an amount to have trigger an association of a one or more advertisements with content retrieved by the content provider based on a match between such keyword and an element of the ad request,
(3) selecting advertisements accessible by the advertising system based on a match between a keyword that will trigger an association of one or more advertisements with content retrieved by the content provider and an element of the ad request, with the advertising system making the advertisements available for selection only after the advertising system determines the amount paid for the keyword has been made,
(4) ordering the advertisements selected at substep (d)(3) for transmission to the content provider based on a ranking according to a probability of each selected advertisement being picked based on a share value range assigned each advertisement according to an amount paid for the keyword being compared to a random number generated by the advertising system, and
(5) transmitting the selected advertisements ordered at substep (d)(4) to content provider; and
(e) the content provider receiving the advertisements transmitted at substep (d)(5) and transmitting such advertisements to the end-user device for display on the end-user device associated with the retrieved content according to the ranking at substop (d)(4).

15. The method as recited in claim 14, wherein advertisers input advertisements into the advertising system for selection.

16. The method as recited in claim 14, wherein the advertising system collects information relating to the end-user accessing advertisements displayed on the end-user device.

17. The method as recited in claim 14, wherein the content provider collects information relating to the end-user accessing the advertisements displayed on the end-user device.

18. The method as recited in claim 14, wherein the keyword includes keywords and phrases.

19. The method as recited in claim 18, wherein matching includes an exact match.

20. The method as recited in claim 18, wherein matching includes matching two or more keywords in a same order.

21. The method as recited in claim 18, wherein matching includes one or more keywords or phrases.

22. The method as recited in claim 14, wherein the method includes a pay per share method.

23. The method as recited in claim 14, wherein the method includes assigning a share value ranges for each advertisement which includes a range being determined by an amount paid by an advertiser for a keyword in relation to a total amount paid for advertisements selected based on the keyword.

24. The method as recited in claim 23, wherein the total amount paid for advertisements selected based on a keyword is a total value range.

25. The method as recited in claim 24, wherein the advertising system generates the random number within the total selected value range for comparison with the assigned shared value ranges for the selected advertisements for the selection of at least one advertisement for transmission to the content provider.

26. The method as recited in claim 14, wherein the advertising system determines a number of selected and ordered advertisements to transmit to the content provider.

27. A method for selecting and ordering advertisements to be transmitted from an advertising system to a content provider for association with content retrieved by the content provider based on a content request for transmission with the retrieve content to an end-user for display, comprising the steps of:
(a) transmitting an ad request from the content provider to the advertising system with the ad request including elements capable of being matched;
(b) selecting one or more advertisements accessible by the advertising system based on a match between a keyword that will trigger an association of one or more advertisements with content retrieved by the content provider and an element of the ad request transmitted to the advertising system by the content provider, and listing the selected one or more advertisements in a first list, and with the advertising system making the advertisements available for selection only after the advertising system determines the amount paid for the keyword has been made;
(c) determining at the advertising system a number of advertisements to be transmitted from the advertising system to the content provider for association with retrieved content that relates to the ad request;
(d) assigning a share value range for each advertisement selected at step (b) based on an amount an advertiser paid for a particular keyword to trigger an association of an advertisement with retrieved content based on a match of that keyword with an element of an ad request in relation to a total value range based on a total amount paid by all advertisers for all of the advertisements selected at step (b);
(e) generating a random number within the total value range of all advertisements listed in the first list determined at step (b) or generating a random number within the total value range of all advertisements listed in the new list determined at step ( );
(f) comparing the random number generated at step (e) with a share value range for an advertisement highest in the first list determined at step (b) or an advertisement highest in the new list determined at step ( ) that has not had its share value range compared with the random number, and if there is a match between the random number and the share value range, then go to step (g) otherwise repeat step (f);
(g) removing the matched advertisement and its share value range from the first list determined at step (b) or the new list determined at step ( ) and storing the removed advertisement for transmission to the content provider;
(h) comparing the number of removed advertisements with the number determined at step (c) and if the number of removed advertisements is equal to the number determined at step
(c), then go to step (k) otherwise go to step (i);
(i) determining if all of the advertisements in the first list determined at step (b) or in the new list determined at step (j) have been selected and if all have been selected, then go to step (k) otherwise go to step (j);
(j) assigning a share value range for each advertisement that remains after step (g) and forming a new list based on an amount an advertiser paid for a particular keyword to trigger an association with retrieved content based on a match of that keyword with an element of an ad request with relation to a total value range based on a total amount paid for all of the advertisements that remain after step (g), and go to step (e); and
(k) transmitting advertisements removed at step (g) to the content provider for display at the end-user associated with the retrieved content in an order that the advertisements were removed at step (g).

28. The method as recited in claim 27, wherein advertisers input advertisements into the advertising system for selection.

29. The method as recited in claim 27, wherein the advertising system collects information relating to the end-user accessing advertisements displayed at the end-user.

30. The method as recited in claim 27, wherein the content provider collects information relating to the end-user accessing the advertisements displayed at the end-user.

31. The method as recited in claim 27, wherein the keyword includes keywords and phrases.

32. The method as recited in claim 31, wherein matching includes an exact match.

33. The method as recited in claim 31, wherein matching includes matching two or more keywords in a same order.

34. The method as recited in claim 31, wherein matching includes one or more keywords or phrases.

35. The method as recited in claim 31, wherein the method includes a pay per share method.

36. The method as recited in claim 27, wherein the amounts paid by advertisers for keywords to trigger the association of advertisements with retrieved content is distributed between the advertising system and the content provider.

37. The method as recited in claim 27, wherein the amounts paid by advertisers for keywords to trigger the association of advertisements with retrieved content is distributed by the advertising system.

38. The method as recited in claim 27, wherein the amounts paid by advertisers for keywords to trigger the association of advertisements with retrieved content is distributed to the content provider.
